(19) United States
(12) Patent Application Publication
(10) Pub. No.: US 2006/0207129 A1
(43) Pub. Date: Sep. 21, 2006

(54) Business card and advertising kiosk

(76) Inventor: Andrew J. Parsley, Corona, CA (US)

Correspondence Address: BUHLER & ASSOCIATES PATENT LAW, SUITE 100, 1101 CALIFORNIA AVE, CORONA, CA, 92881, US

(21) Appl. No.: 11/072,968

(22) Filed: Mar. 4, 2005

(51) Int. Cl. G09F 1/00; G06Q 30/00

(52) U.S. Cl. 40/124.03; 40/124.08; 705/14

(57) ABSTRACT

A business advertising system is disclosed that allows for viewing and dispensing of business cards or other printed media from multiple businesses. The system may further be configured with a closable and or lockable door that allows viewing and also protection of the cards. The system may also include a receptacle to allow additional business to leave cards. The business advertising system may also include an active display devise that provides additional or supplemental information on the businesses being advertised. The active display may be provided by a scrolling message, TV, touch screen or kiosk. The active display may include sound, with commercials for the companies that are being advertised. The system provides multiple methods of revenue from the placement display and use of the business cards.

### FIELD OF THE INVENTION

This invention relates to new and useful improvements in apparatus for displaying, dispensing business cards and a business method for the display system. More particularly, the present invention relates to a structure that displays multiple business cards and or advertisement for companies where a customer can select or take business cards. The invention may also include active advertising or graphics such as crawling text display, TV or touch screen where additional information can be found, displayed or heard. The display system provides a revenue stream for the companies being displayed, the business showing the cards, and promotional company that provides the connection between the two parties.

### BACKGROUND OF THE INVENTION

Companies are always looking for ways to promote their business and bring in more business. One of the simplest methods of promoting a business is by distributing business cards. Business cards are handed out to people that may be in need of the service a company has to offer. In an ideal world a person needs to be in as many places as possible to distribute business cards. For most small businesses the sales staff is often the only staff, and the need to service and sell to customers are equally important. People often need to locate companies that offer products or services. The service can be anything from dry cleaning, to car service or pet grooming. The service to connect the two parties has tremendous potential for revenue.

Several patents have been issued that provide some of the features proposed but none provide all the features in an easy to display, dispense and retrieve system with an active advertising display and provides a revenue stream.

Patent number 5,983,546 issued to Aiken, Sr. on Nov. 16, 1999 discloses an information strip for scrolling signs. This patent discloses an active moving sign for displaying various food products. This invention requires a user physically change the information on the moving display. It does not provide a location for business cards to be located so a customer can take some information such as the phone number or the address of the company for future reference or use. The invention further does not provide for temporary security of the product if it is placed in a location that may be affected by weather or vandalized.

Patent number 5,634,668 issued to Barreiro, Jr on Jun. 3, 1997 discloses information indexing method and apparatus. The invention consists of a board with locations for numerous business cards to be placed. In addition to the business cards a book is located that allows a customer to receive additional information about each company. While this system provides business cards with some additional information regarding each company, the invention does not provide for active advertising that attracts customers. The invention further does not provide for temporary security of the product if it is placed in a location that may be susceptible to weather or vandalized.

Patent number 5,046,273 issued to Virvo on Sep. 10, 1991 discloses a portable display system. The portable display system consists of a collapsible display that can hold business cards and other static advertising information. While this invention provide for the display of information and business cards, it does not provide for an active advertising system or the display of business cards from multiple companies. The invention further does not provide for temporary security of the product if it is placed in a location that may be susceptible to weather or vandalized.

What is needed is a simple method that allows business owners and customers to connect in a simple method. The proposed invention provides this solution by providing business cards in a display case whereby business owners can leave business cards, and customers can select business cards that can provide the services they are looking for. It would allow a display system that allows for multiple companies to display their businesses. The display would also include an active display and or sound advertising system that promotes companies that have business cards being displayed. This system would further allow for security of the system when no one was available to protect it from weather or vandalism. The ideal system would also provide a location for additional businesses to leave cards for future advertising. This system would further provide a revenue method for displaying the business cards. The proposed device satisfies these needs.

### BRIEF SUMMARY OF THE INVENTION

The present invention relates to an advertising and display system for business cards. The display and advertising system consists of a rack for storing and displaying business cards from multiple companies. The business cards from each company can be viewed at the same time. The system also provides for a securable cabinet that reduces the potential for vandalism while still allowing the business cards to be viewed. This system also provides a receptacle for additional businesses to add their cards to the display system when the cabinet is secured. An active display and or sound system provide promotional and or advertising information on a continuous basis.

One of the objects of this invention is to provide multiple holders for business cards from variety of different companies to allow people to view and take the business cards they might need now or in the future.

Another object of the invention is to provide a business card display and advertising system where the business cards can be secured behind a closable and lockable panel.

Another object of invention is to provide that the security closure while still security allows viewing of multiple business cards on display. This will allow the advertising of the businesses to still be viewed while protecting the business cards from weather and or vandalism.

Another object of the invention is to provide an opening in the enclosure whereby additional businesses can place business cards to be displayed at a future time.

Another object of invention is to provide an active display system that further promotes one or more of the businesses from the business cards that are being displayed. This active displayed allows a greater level of advertising and promotion that is not available from a static display of business cards alone. Another object of invention is to provide an active audible advertising system that further promotes one or more of the businesses from the business cards that are being displayed. This active sound system allows a greater level of advertising and promotion that is not available from a static display of business cards alone.

Another object of the invention is that the active display system also incorporates a kiosk type device whereby potential customers can request additional information.

Still another object of the invention is to provide and a printing function to allow potential customers to print out additional information regarding the companies that are showing business cards.

Still another object of the invention is to provide a method of providing revenue for the company that provides the display system and the company that displays the business cards.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an isometric view of the business card display system with scrolling advertising.

FIG. 2 is an isometric view of the business card display system with a monitor or TV that provides information on the businesses being promoted.

FIG. 3 is an isometric view of the closable and lockable business card displaying enclosure.

FIG. 4 is an isometric view of a business card display system with a kiosk with a user input device and a printer one.

### DETAILED DESCRIPTION

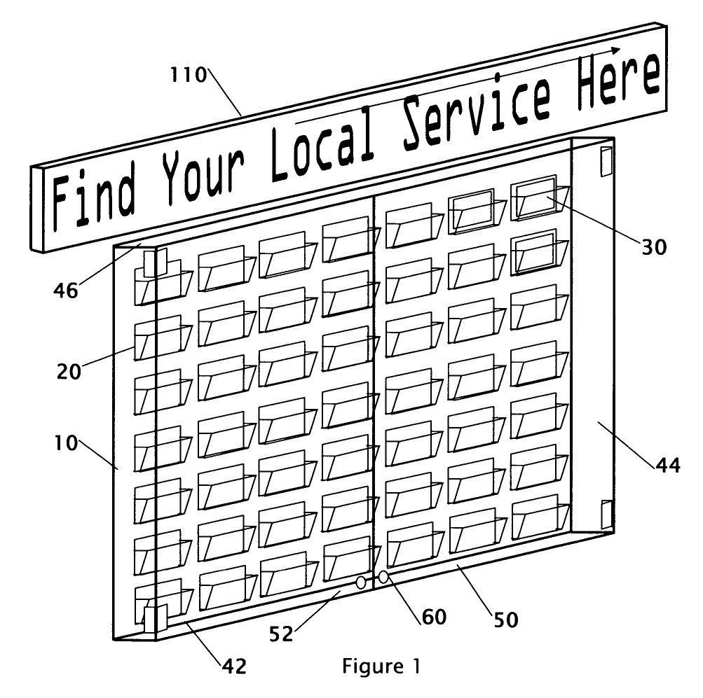

Referring to FIG. 1, there is shown an isometric view of the business card display system with scrolling 100 advertising. The display system consists of an essentially flat backboard 10. The backboard provides a support structure for the remainder of the product. On the backboard a number of holders 20 for business cards 30 are located. In the preferred embodiment the holders are placed orthogonally on the backboard, but the holders can be placed in a circular or diagonal arrangement. Other arrangements can be utilized that allow for the displaying of business cards. In the one of the preferred embodiments holders for 49 cards are placed in an arrangement of seven across by seven high as shown in FIG. 1. A number of other configurations that allow for more or less cards to be placed in the display system. Each business card holder 20 allows for multiple business cards to the displayed for purposes of advertising and distribution. Each individual cardholder is made from a transparent material so the information on the card can be seen. In the preferred embodiment the business cards are freely placed and removed from the holder, but another embodiment of the holder is contemplated that allows for a single card to be placed in a permanent or semi-permanent holder whereby the last card cannot be removed but the information can still be copied. In this embodiment the permanent or semi-permanent card can be adhered or placed in front of the business cards in the cardholder. If the configuration utilizes a business card placed on the front cardholder, the card holder can be constructed of a non-transparent material. In the preferred embodiment the housing is made out of transparent material such as Lexan, Polycarbonate, or similar material, but the enclosure can be made from any material including but not limited to plastics, glass, fiberglass, wood, fabric, rock or metal.

The display board is constructed within a clear enclosure. This clear enclosure has elongated sides that 40, 42, 44 and 46. The elongated sides allow some protection of the business cards placed within the display system. The elongated sides also provide support for doors 50 and 52 that can be closed. While in this embodiment two doors are used, a single door, more than two doors or no door can be used. The doors are transparent to allow the business cards to be viewed while the door(s) is closed. The door(s) provides several functions including but not limited to security, weather protection of the cards within the enclosure, protection and viewing of the cards within the cabinet. The enclosure may also be equipped with a lock 60 that can allow the enclosure to be secured to prevent vandalism or damage to the information within the enclosure. This figure shows a scrolling message display 100 placed above the business card display cabinet.

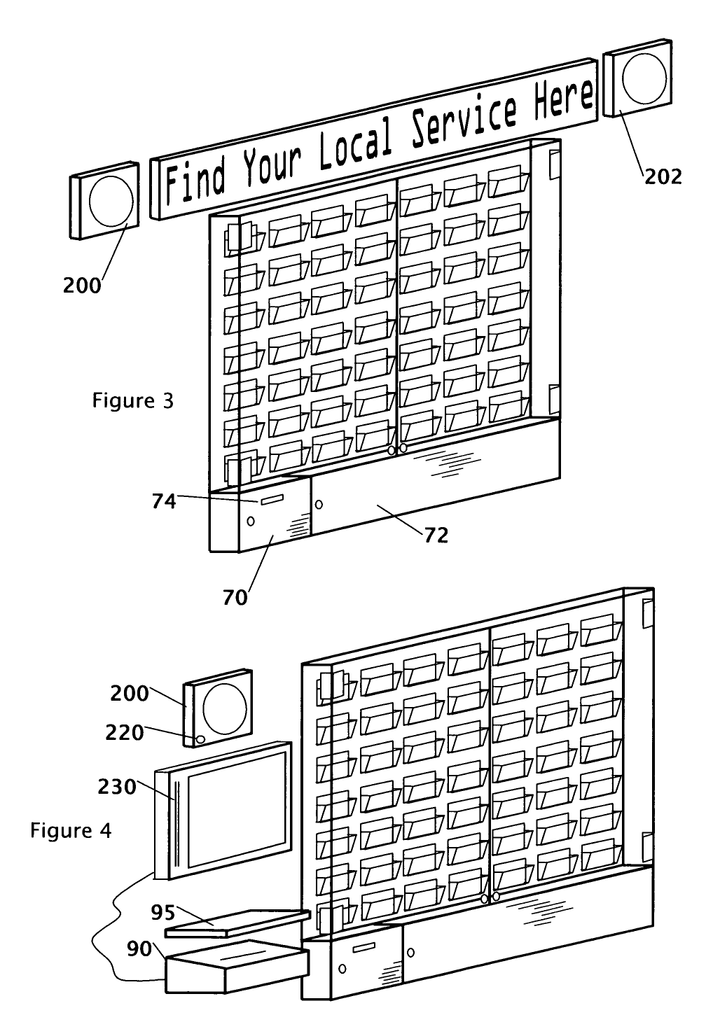

The message display 110 in this figure is an LED type display board that allows for messages to be displayed in a scrolling manner. The LED display shows text and or graphical information and allows further advertising information on the companies that have business cards in the case. The LED display is shown here with multi-colored LED's, but a single color LED can be used. Other configurations of displays are contemplated and disclosed in other embodiments. The display is utilized as an attraction feature to encourage people to take one or more of the business cards that are being shown. One or more speakers 200 and 202, shown in FIG. 3, can also be installed to allow sound to be used as an attraction feature to further encourage people to look at the business cards and take one or more business cards for future use of services or products.

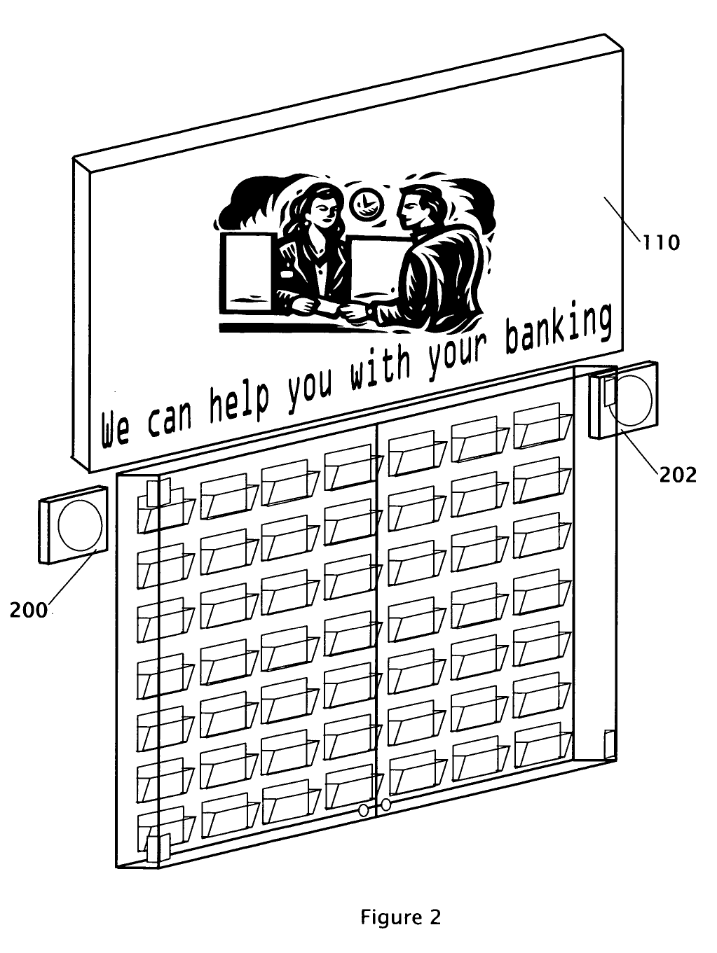

Referring to FIG. 2 there is shown an isometric view of the business card display system with it a 110 monitor or TV that provides information on the businesses being promoted. In this configuration the TV or monitor can show advertising or commercials on the companies being displayed. The advertising consists of short or long segments of advertising intended to further promote the companies or encourage people to take business cards for products or services. The display system in this embodiment is a standard CRT TV or plasma, LED, projection, LCD or other method of displaying moving images. The display is operated from a VCR, DVD player computer or similar device that can display a loop of information or commercials. It is also contemplated that the information come from a cable, dish or DSL provider where the signal can be changed and transmitted from a distal location to the monitor and or speakers 200 and 202.

FIG. 3 is an isometric view of the closable and lockable business card displaying enclosure. This figure shows a view the business card display with a lower cabinet 70 and 72. The lower cabinet includes one 72 compartment 72 for holding supplies and additional cabinet 70 with opening 74 for placing business cards for additional companies that may wish to advertise in the future.

FIG. 4 is an isometric view of a business card display system with a kiosk with a user input device and a printer one. The printer 90 can be used to print additional information regarding each company. This information can include pricing, menus or even business cards. When a kiosk is utilized the kiosk may include a touch screen 112 to allow a potential customer to select specific businesses and get additional or more detailed information regarding each business or businesses. The kiosk may also be connected to the internet or similar outside communication device that can allow the kiosk to link to the web site of the business or to send an email to the business as a request for additional information or to be contacted. In this configuration a shelf 95 is provided as a writing surface. Speaker 200 is also shown to provide audible information. A microphone 220 may also be provided in the case the kiosk has internet or phone access, and a person can talk with a live person at a company or leave a voice message for a company for future contact. It is also contemplated that the kiosk includes a camera or other device to allow a visual image of the customer at the kiosk. A card reader 230 or other similar system may also be incorporated to purchase a service at the same location, for example flowers to be delivered.

The display system is shown to distribute and display business cards, but the system can also be used for the display and distribution of material other than business cards. Other material that is contemplated includes brochures, fliers, menus, coupons, pamphlets, calendars or other promotional items.

The display system also consists of a business method for promoting the businesses. This method consists of collection money from each company that is being promoted as a one time or fixed interval such as monthly for displaying each business. The business method allows for a revenue stream of money to pay for the opportunity to display and promote companies. This also provides companies to promote their businesses in places where they might not normally be allowed to promote businesses. Placement from for this type of advertising and display can best be located where potential customers are present and waiting for services or products. The services or products can be medical, financial, car wash, car repair, mailing services, airport services or other similar services or product where a customer or potential customer is waiting or passing time. The product provides both an entertainment function and provides information such as food, dry cleaning, legal, business, banking, investment, insurance or other similar services.

Thus specific embodiments and applications for an advertising business and method have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A business advertising system comprising:
A display rack configured for dispensing at least two different business cards where the display rack further includes an active visual display system.

2. The business advertising system from claim 1 wherein the active display system is a TV, LCD, plasma, LED or CRT display.

3. The business advertising system from claim 1 that further includes a touch screen.

4. The business advertising system from claim 1 that further includes at least one audio component.

5. The business advertising system from claim 1 that further includes a printer.

6. The business advertising system from claim 1 that further includes a credit card or debit card reader.

7. The display rack from claim 1 wherein the display rack is made from at least one or a combination of plastic, metal, glass, fabric, rock, or something other than plastic, metal, glass, fabric and rock.

8. The closable housing from claim 1 wherein the closable housing allows for viewing of the business cards when the housing is secured.

9. The business advertising system from claim 1 wherein the advertising system generates income from the companies or services being displayed.

10. The business advertising system from claim 1 that further includes at least one opening for placement of business cards from companies that would like to be added to the display rack.

11. A business advertising system comprising:
A display rack configured for dispensing at least two different business cards where the business cards are located within a closable housing that allows for both dispensing and temporal security of the business cards.

12. The business advertising system from claim 11 further includes an active display system such as a TV, LCD, plasma, LED or CRT display.

13. The business advertising system from claim 11 that further includes a touch screen.

14. The business advertising system from claim 11 that further includes at least one audio component.

15. The business advertising system from claim 11 that further includes a printer.

16. The business advertising system from claim 11 that further includes a credit card or debit card reader.

17. The display rack from claim 11 wherein the display rack is made from at least one or a combination of plastic, metal, glass, fabric, rock, or something other than plastic, metal, glass, fabric and rock.

18. The closable housing from claim 11 wherein the closable housing allows for viewing of the business cards when the housing is secured.

19. The business advertising system from claim 11 wherein the advertising system generates income from the companies or services being displayed.

20. The business advertising system from claim 11 that further includes at least one opening for placement of business cards from companies that would like to be added to the display rack.
